(19) United States
(12) Patent Application Publication
(10) Pub. No.: US 2020/0356929 A1
(43) Pub. Date: Nov. 12, 2020

(54) Mining System

(71) Applicant: Technological Resources Pty. Limited, Red Hill (AU)

(72) Inventors: Tamara Vasey, Red Hill (AU); Danielle Robinson, Red Hill (AU); Arman Melkumyan, Red Hill (AU); Alex Lowe, Red Hill (AU)

(21) Appl. No.: 16/961,115

(22) PCT Filed: Dec. 20, 2018
(86) PCT No.: PCT/AU2018/051374

§ 371 Date: Jul. 9, 2020

(30) Foreign Application Priority Data
Jan. 9, 2018 (AU) 2018900051

(51) Int. Cl. G06Q 10/06; E21C 41/26; G06N 20/00; G06N 5/04

(52) U.S. Cl. CPC G06Q 10/06311; E21C 41/26; E21B 49/02; G06N 5/04; G06N 20/00

(57) ABSTRACT

The current invention relates to mining systems and mine planning and in particular, to operating a mine that automatically updates a mine plan. The mining system directs operation of mining equipment within a mine based on a mine plan that schedules operations in the mine. The system further includes a mining planning system for updating the mine plan by a learning module configured to determine an inferencing model from initial data obtained from a data input module. The inferencing model is then evaluated by an estimation module using the initial data and the measurement data wherein such evaluation provides a fusion model. Consequently, a mine planner module determines an updated mine plan based on an existing mine plan and the fusion model. Based on the updated mine plan, the mining system directs operation of the mining equipment within the mine.

### TECHNICAL FIELD

The present disclosure relates, generally, to mining systems and mine planning and, more particularly, to operating a mine that automatically updates a mine plan.

### BACKGROUND

Mine plans are used to plan mining operations, for example, by scheduling drilling, blasting and digging. The daily operation of a mine consists of a series of decisions regarding the ore to be extracted from the mine, a block at a time. Mine plans are based on orebody estimates for the region to be mined so that scheduled operations are based on those estimates. In order to extract the right tonnage and quality of ore to meet daily or short term targets, a mine plan is created based on the optimal sequence of extraction of blocks. The better the orebody estimates are, the better the mine plan can be configured for meeting production targets.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

In one aspect there is provided a mining system for directing operation of mining equipment within a mine based on a mine plan that schedules operations in the mine, the system including: a mine planning system for updating the mine plan, the mine planning system including: a data input module providing initial data, and measurement data; a data processing module including: a learning module configured to determine an inferencing model from the initial data; and an estimation module configured to evaluate the inferencing model using the initial data and the measurement data, wherein thus evaluating the inferencing model provides a fusion model; and a mine planner module that determines an updated mine plan based on an existing mine plan and the fusion model, wherein the mining system directs operation of the mining equipment within the mine based on the updated mine plan.

The measurement data may include a plurality of data sets with varying dimensionality. The estimation module may accommodate the plurality of data sets with varying dimensionality by using a unified data representation.

The learning module may further be configured to update the inferencing model based on the measurement data. Updating the inferencing model may include updating one or more model parameters of the inferencing model. The mining system may further include a validator module that assesses the fusion model in view of the measurement data to prompt the learning module to update the inferencing model.

The measurement data may include production measurement data obtained continuously during operation of the mine.

The estimation module may estimate an updated orebody model based on the fusion model, and the mine planner module may use the updated orebody model to determine the updated mine plan.

The initial data may include exploration data and measurement data.

In another aspect there is provided a method of directing operation of mining equipment within a mine based on a mine plan that schedules operations in the mine, the method including: updating the mine plan, the updating including: receiving initial data; determining an inferencing model and its model parameters from the initial data; receiving measurement data; using the received measurement data and the initial data to evaluate the inferencing model to determine a fusion model; and determining an updated mine plan based on the mine plan and the fusion model; and directing operation of the mining equipment based on the updated mine plan.

The method may further include updating an orebody model from the fusion model, and determining the updated mine plan may also be based on the updated orebody model.

The method may further include validating the fusion model in view of the measurement data to provide a validation measure, and prompting the updating based on the validation measure.

The initial data may include exploration data.

The measurement data may include production measurement data received continually during operation of the mine.

The measurement data may include a plurality of data sets with varying dimensionality.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the disclosure are now described by way of example with reference to the accompanying drawings in which:—

FIG. 1 illustrates a schematic representation of a mineral deposit;

FIG. 2 illustrates a basic schematic representation of a simplified open-pit mine;

FIG. 3 illustrates an embodiment of a computer system for modelling data and determining an updated estimate for a material property of a volume;

FIG. 4 illustrates an embodiment of a method for updating a mine plan;

FIG. 5 illustrates a schematic block model for in-ground material property of a mineral deposit;

FIG. 6 is a schematic representation of an embodiment of a mine planning system; and

FIG. 7 illustrates another embodiment of a method for updating a mine plan.

### DETAILED DESCRIPTION OF EXEMPLARY EMBODIMENTS

### 1. Mine Operation Overview

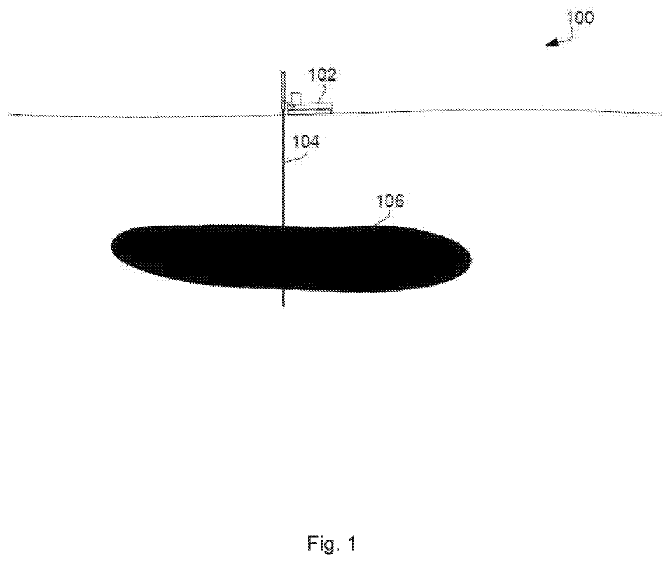

FIG. 1 illustrates a simplified exploration scenario 100. A drill 102 drills a drill hole 104 and extracts a sample of material from the drill hole 104. Based on an analysis of the sample, a resource 106 is located based on an initial estimate for a material property of a volume. Additional drill holes give a more accurate view of the exact dimension of the resource 106 but also incur a significant cost, such as the cost of creating drill pads, drill equipment hire, and manpower. Therefore, a resource company is presented with a trade-off between upfront cost and information quality.

Once the resource company is sufficiently informed about the parameters of the resource and its economic potential, the resource company starts the development of a new mine. Once preparation of the mine site has been completed, such as removal of overburden, to gain access to an ore deposit, blast hole drill rigs are dispatched and blast holes are drilled into the ore deposit. The drilled blast holes are loaded with explosives. After blasting, digging equipment, such as shovels, move to the blast site and start loading the freed ore onto trucks, which transport the material either for further processing or to a waste pile (if the ore grade is below a predetermined threshold).

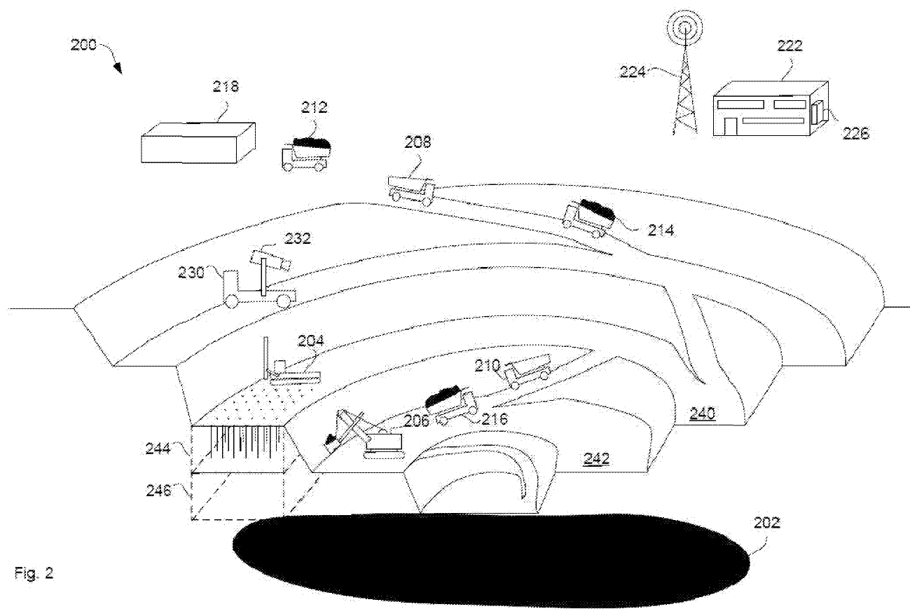

FIG. 2 illustrates a simplified open-pit mine 200. Although FIG. 2 shows an open-pit operation, it is to be understood that the principles disclosed herein are equally applicable to underground operations. The mine 200 has one or more of each of the following: a deposit such as, for example, an iron ore deposit 202, a blast hole drill rig 204, a shovel 206, empty trucks, or load haul dumpers (LHDs), 208 and 210 and loaded LHDs 212, 214 and 216. As mentioned above, the drill rig 204 drills blast holes, the material is blasted and then loaded onto an LHD 210. The LHD 210 then transports the material to a processing plant 218. While some of the following examples relate to the mining of iron ore, it is to be understood that the methods and systems described herein are also applicable to mining operations associated with other mineral deposits, such as coal, copper or gold.

In the example shown in FIG. 2, the mine layout has several benches, such as bench 240 on which blast hole drill rig 204 is located and bench 242, which is below bench 240 and on which excavator 206 is located. Bench 240 has a first volume 244 of material between the level of the blast hole drill rig 204 and the level of the shovel 206. Bench 242 has a second volume 246 of material below the shovel 206 and above the next level below.

The mine 200 also has a control centre 222 with which an antenna 224 is associated and hosting a computer 226. The control centre 222 monitors operation data received from the mining machines wirelessly via the antenna 224. In one example, the control centre 222 is located in proximity to the mine site while in other examples, the control centre 222 is remote from the mine site, such as in the closest major city or at the headquarters of the resource company.

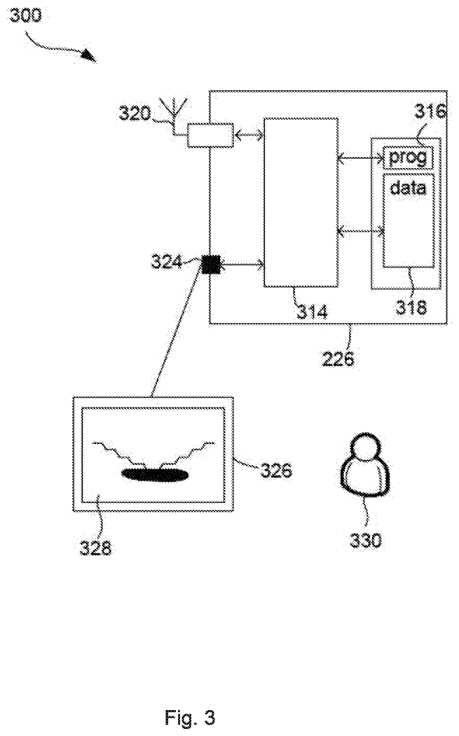

FIG. 3 illustrates an embodiment of a computer system 300 that includes the computer 226 located in the control centre 222 in FIG. 2. The computer 226 includes a processor 314 connected to a program memory 316, a data memory 318, a communications port 320 and a user port 324. Software stored on program memory 316 causes the processor 314 to perform the methods or parts of the methods described herein. The processor receives measurements and determines and/or updates the initial or an additional estimate for a material property of a volume. The processor 314 receives data from the data memory 318 as well as from the communications port 320 and the user port 324. The user port is connected to a display 326 that shows a visual representation 328 of a geological model to an operator 330.

Although communications port 320 and user port 324 are shown as distinct entities, it is to be understood that any kind of data port may be used to receive data, such as a network connection, a memory interface, a pin of the chip package of processor 314, or logical ports, such as IP sockets or parameters of functions stored on program memory 316 and executed by processor 314. These parameters may be handled by-value or by-reference in the source code. The processor 314 may receive data through all these interfaces, which includes memory access of volatile memory, such as cache or RAM, or non-volatile memory, such as an optical disk drive, hard disk drive, storage server or cloud storage. The computer system 300 may further be implemented within a cloud computing environment

### 2. Updating the Mine Plan

Although the iron ore deposit 202 is indicated as a solid region, it is to be understood that the exact shape of the deposit 202 is not known before it is mined. Modelling software executed on the computer 226 provides an estimate of the deposit 202 based on the exploration drilling as explained with reference to FIG. 1. However, because the cost of exploration drilling is high, the estimated material property for particular volumes may be locally inaccurate, and such inaccuracies make it difficult to plan the mining operation well.

In one example, the material property is iron concentration, such as a percentage of iron (Fe) in the iron ore deposit. In other examples, the material property is the concentration of different materials, such as copper, the hardness of the material or the lump ratio (where “lump” is a term for fused or pieces of iron ore that are larger than a threshold size, such as 25 mm and generally attract a higher price on the world market than fines, which are below that threshold size). In some embodiments the material property may include a property with a continuous value and/or a categorical property.

In order to provide a more accurate estimate, in the methods and systems described herein the estimate of the deposit 202 is continuously updated by measurements received from the blast hole drill 204. Therefore, the data from the blast hole drill 204 (which includes measurement while drilling, MWD, data) helps to reduce the uncertainty of the estimate of the deposit 202. The result is that the estimate is of a better quality and can in turn be used to update the mine plan, thereby improving production efficiency.

Typically for open pit mines, the volume of material to be extracted over the lifetime of a mine is divided into blocks. In one example, each block is a cuboid, but it is to be understood that the methods described herein are equally applicable to other regular volumes, such as tetrahedron or honeycomb structures, and also to irregular volumes. The size of the blocks vary and are subject to the resolution of geological modelling. Mining tasks are typically performed in batches on a cluster of blocks referred to as herein as patterns.

A mine plan is created based on the optimal sequence of extraction of patterns. A mine plan includes drilling, blasting and digging schedules for ore extraction at the benches in a mine, typically with a specific order of blocks within the sequence of patterns.

In long term plans the objective is typically to maximise the net present value (NPV) of the mine. In short term and daily planning the aim is typically to meet targets for that time period. Short term plans may deviate from long term plans in cases where the estimated tonnage and quality of ore in a block varies from samples obtained in drill assays. Updating the estimate of the deposit 202 can therefore be used to update the mine plan and, in particular, the short term plan, to more effectively operate the mine for meeting production targets. This is referred to as grade control.

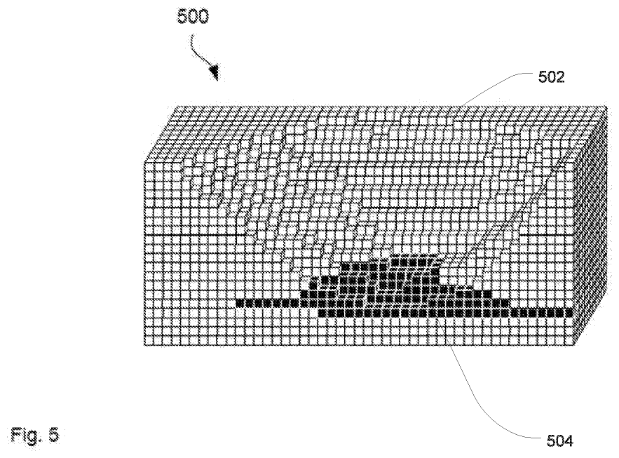

In one example, the mine plan determines that the first bench 240 on which the blast hole drill rig 204 is currently operating needs to be blasted. This decision is made and does not require an update of material estimates of that bench while the blast holes are drilled. However, the planning of further blasting of the second bench 242 below the first bench 240 at a later stage is not yet finalised. This means that a more accurate update of material estimates of the second bench 242 supports the planning tool. Where a relationship between the material properties in the upper bench 240 and the lower bench 242 can be determined, measured material properties from the upper bench 240 may be used to update the estimate of material property of the block 246 associated with the lower bench 242. An association of the measurement with a bench may be implemented by storing the measurement as a number value together with a unique pattern identifier as one record in a database, which may form part of the data memory 318 or be a separate data storage device. As mining progresses more and more benches get drilled and blasted providing new information which can be fused with the existing estimates to update and improve the mine plan (for example fused to determine the ore control model, OCM 500, as described elsewhere herein with reference to FIG. 5).

It is noted here that the bench 242 in FIG. 2 is immediately below bench 240. However, this immediate neighbouring relationship is not necessary since the estimate of a volume in a lower bench may be updated using measurements from a higher bench even if one or more benches are between the lower bench and the higher bench. The larger the distance between the estimated location of the volume and the measurement location where the measurement is taken, the less influence the measurement has on the estimate. However, the estimate may still be better, that is, may have a higher confidence, than without using the measurement in cases where the measurement and the estimate are geologically correlated. It is to be understood that the methods described herein are equally applicable to horizontal or other directional separations between measurement locations and estimate locations.

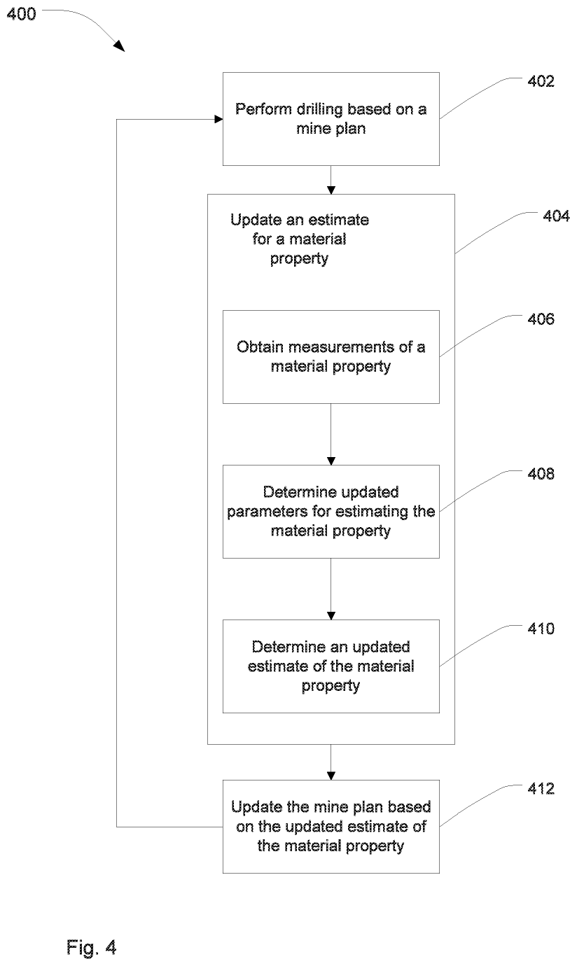

FIG. 4 illustrates a method 400 of directing operation of mining equipment within a mine based on a mine plan that schedules operations in the mine. The method 400 includes updating the mine plan based on updating material property estimates associated with a volume of material. At 402 the existing mine plan, based on initial material property estimates determined using initial data, provides a drilling schedule which is executed and, when executed, the operations provide measurement data, e.g. MWD data. At 404 the measurement data is used to update the material property estimate. The updated material property estimate is for a predictive volume of material for which there is no or little measured data. At 412, the updated material property is used to update the mine plan according to which drilling will continue at 402 so that the operation of the mining equipment is directed based on the updated mine plan. In addition, the updated mine plan may provide an input according to which future mine plans and/or existing longer time-horizon mine plans are revised.

In some embodiments the measurement data includes production measurement data. In some embodiments the measurement data may also include exploration data.

Updating the estimate at 404 is done by first obtaining the measurement data at 406, e.g. the processor 314 receives the data which has been stored in data memory 318, from the communications port 320, and/or from the user port 324 (the data originating, for example, from the drill rig 204, a laboratory, or another system). Optionally, at 408 updated model parameters for the estimation model are determined. For example hyperparameters for a Gaussian Process model are determined based on both the existing estimated data as well as the new measurement data, as described elsewhere herein. In some embodiments the model parameters are not updated and step 408 may be omitted. At 410 an updated estimate of the material property is determined based on a combination of the existing estimated data and the new measurement data, and also based on the updated model parameters in embodiments where such updated parameters are determined.

### 2.1 Estimating the Material Property

FIG. 5 illustrates a block ore control model (OCM) 500 for an in-ground material property. The OCM partitions the underground material of a mine into multiple volumes (blocks), and assigns a material property estimate to each block. In this example, the blocks are cubes, but other three-dimensional shapes are also possible to define a volume, such as a honeycomb structure. In the example of FIG. 5, a white block 502 indicates waste and a black block 504 indicates the deposit, such as an iron ore deposit. In one example, a block is considered waste if the concentration of iron in the block is below a predetermined threshold, such as 50% iron, and vice versa, a block is considered as part of the deposit if the iron concentration in the block is above the threshold.

### 2.1.1 Gaussian Process: Learning Procedure

The material property estimate that is assigned to each block is initially estimated using regression and is based on initial data. The initial data may include exploration data and/or production measurement data. Exploration data is typically obtained before mine operation commences. Exploration data has a relatively low resolution or granularity, with measurements being spaced widely apart.

The material property estimates per block are calculated using a non-parametric, probabilistic process, such as a Gaussian Process (GP) that is suitable for determining a multi-scale representation of the exploration data. The probabilistic process is used to learn relationships between the exploration data, such as learning parameters for a covariance function (kernel). The statistical model derived in this way is referred to herein as an “inferencing model”. The relationships learnt using the probabilistic process (e.g. using a GP) are in turn used to estimate material properties in the inferencing model.

The GP has a covariance function that defines the covariance between two values of the model and declines with the distance between the two values. Therefore, the covariance function defines whether the data changes rapidly or not over distance. Different types of covariance functions are suitable for different types of data, with suitable examples including Square Exponential, Exponential, Matern 3/2, and Matern 5/2.

Each covariance function (also termed kernel) has model parameters that characterise the covariance function. In one example, the parameters of the kernel may include a scaling factor σ0, and/or a characteristic length l, which describes how quickly the covariance function changes. For simplicity of presentation, a one dimensional characteristic length is used here but it is to be understood that two or three dimensional vectors may equally be used. In one example, characteristic length scales lx, ly, lz are used. The GP may also use parameters such as a noise component an to build the GP model along with the covariance function.

As used herein “model parameters” refers to the covariance function (i.e. the kernel) together with the parameters associated with both the covariance function and with the GP, e.g. a scaling factor, characteristic length, and/or a noise parameter, etc. The model parameters are sufficient to build the GP model along with the input data. Therefore the estimation of the material property using the GP model is based on the model parameters.

Since these parameters define the GP model, the estimation of the material property using the GP model is based on the model parameters.

The GP method starts with a machine learning procedure, in this example a GP learning procedure in which hyperparameters associated with the GP covariance function are optimised. Determining the parameters of the covariance function is typically performed based on the available data, that is, the exploration data of FIG. 1 (in some embodiments in combination with blast hole assays). In some embodiments, geological spatial information may be used. An optimisation algorithm, such as a steepest gradient descent algorithm, is used to iteratively optimise a cost function which is based on the parameters such that the fit to the given data is optimal. By “optimise” it is meant that the hyperparameters are set at values that are expected to result in reduced error in comparison to other values, but are not necessarily set at the most optimum values.

Closed form partial derivatives of the cost function with respect to the parameters may be used to speed up the GP learning procedure and are described in PCT/AU2014/000025 filed on 16 Jan. 2014 and incorporated herein by reference in its entirety.

### 2.1.2 Gaussian Process: Evaluation Procedure

Once the hyperparameters have been determined, an evaluation procedure, in this case a GP evaluation procedure, is used to provide the GP model of the material property at a desired resolution and across the orebody for each block in the relevant pattern.

In the example shown in FIG. 5, the horizontal resolution of the OCM 500, that is, the number of blocks in a horizontal layer of the OCM 500, is higher than the number of exploration drill holes 104 described with reference to FIG. 1. As a result, many blocks of the OCM 500 are between drill holes and therefore, no measurement of the material property is available. The GP model is able to provide estimates for those in-between blocks where no measurements were taken.

### 2.2 Updating the Estimated Material Property and the Mine Plan

The relevant material property is estimated by evaluating a GP model based on a specific covariance function, and having model parameters, e.g. scaling factors σ0, σn and the characteristic length l, or characteristic length scales Ix, ly, lz. These model parameters were initially determined based on initial data as explained with reference to FIG. 1.

The first step of updating an estimate for a material property is to obtain measurements of the material property in order to provide production measurement data, e.g. blast hole sample assays, measurement while drilling (MWD) data, etc. The measurements of the material property may be obtained from outside the volume. Outside the volume means that at least part of the measurement is obtained from data obtained outside the volume for which the property is being estimated. In the example of FIG. 2, the measurements are of the material property of volume 244, which is outside volume 246. In another example, a drill hole in bench 240 may reach into a block in bench 242 but a part of the drill hole is outside of bench 242, that is, in bench. Therefore, the measurement is outside the volume (e.g. the block or pattern) that models bench 242.

In the example of FIG. 2, the processor 314 in computer 226 receives measurement data from blast hole drill rig 204. The measurement data is received over time as mine operation progresses and the mine plan is executed. The measurement data is used to update the GP model of the material property in the orebody and to update the estimate of the material property in the orebody 106.

In some embodiments updating the GP model includes evaluating the GP model using the original covariance function and model parameters, using subsequent production measurement data for the evaluation. In other embodiments updating the GP model may also include determining updated model parameters based on the production measurement data, and then using the measurement data for the evaluation. As described in more detail elsewhere herein, evaluation of the inferencing model may be based on a combination of initial data and one or more sets of production measurement data.

### 2.2.1 Unified Data Representation

The measurement data may have a different resolution and/or granularity when compared to the exploration data because more measurements are taken during drilling than during exploration. The measurement data also has different characteristics when compared to the estimates of the material property, because the dimensions of the measurement data dataset and the estimated material property dataset differ. There may also be differences in the characteristics of the measurement data before and during mining, for example exploration data compared to blast hole sample assays. In order to accommodate these differences, the system described herein may use a unified data representation in order to determine and update the relevant models.

To understand what the measurement data typically looks like, refer to FIG. 2 where a blast hole is drilled by a blast hole drill rig 204 in a direction towards the deposit 202. While the blast hole is being drilled, drill chips are blown out of the blast hole and form a collar around the opening of the blast hole. Typically, an on-site worker or a sampling machine then obtains a sample of the drill chips from the collar and chemically analyses the sample to measure the material property in the blast hole. Since the drill chips are a mixture of chips from throughout the blast hole, the measurement represents a line average of the material property along the length of the blast hole. The line average may be, for example, 20% of iron along the length of the blast hole. The line average is associated with a position of the blast hole in the form of a set of x, y and z coordinates, such as longitude, latitude and elevation. Blast hole data may be in the form of point data for short drill lengths, or line average data for longer drill lengths, i.e. zero dimensional or one dimensional, respectively. Therefore, the measurement data includes multiple data sets of varying dimensionality.

The characteristics of blast hole data and the relevance to updating estimates of material properties are described in PCT/AU2014/000025.

The OCM 500, on the other hand, provides an estimate of the material property associated with each three dimensional block. In order to use a GP model that provides updated estimates to update the OCM, the system described herein therefore has to be able to use different datasets with different dimensions, such as the zero or one dimensional averages provided by the measurement data.

For both the OCM estimates and blast hole assays it is possible to represent the i-th input as a volume Vi. In order to accommodate the different datasets, a unified data representation is used as described in PCT/AU2014/000025. Specifically, the second set of data values (the measurement data) is to be fused with the first set of data values (the existing model of the estimates, for example as determined based on exploration and/or older blast data), which means that both data sets contribute to a single result. The processor 314 stores for each value of the second set an association with an anchor point A and a size vector H. The anchor point and the size vector have the same number of spatial dimensions as the first set of data values. The result is the updated values of the model parameters (e.g. hyperparameters) and/or the updated estimate for the material property (e.g. the updated orebody model or OCM).

Accordingly, the data sets with varying dimensionality are accommodated in the systems and methods described herein by using a unified data representation.

### 2.2.2 Updating the GP Model and Model Parameters

As more data becomes available from blast hole drill rig 204, the processor 314 performs an optimisation to fit the GP model to the new data. As a result, the processor 314 uses the new data to determine updated values for σ0, σn and l, or lx, ly, lz, based on the initial data and the subsequent measurement data (for example from the blast hole drill rig 204, e.g. MWD data).

The exact mathematical description of the updating process is described in PCT/AU2014/000025 which is hereby incorporated in its entirety by reference.

In embodiments where the model parameters σ0, σn and l, or lx, ly, lz, are updated based on new blast hole drill data, the GP model may provide a more accurate estimate of the material property. The processor 314 therefore evaluates the updated GP model to determine an updated estimate for the material property of the volume. Since the processor uses the updated GP model, this updated estimate is based on the updated values for the model parameters σ0, σn and l, or lx, ly, lz, and the blast hole drill data.

The GP model also provides a more accurate estimate of the material property because it uses more data as input (i.e. measurement data), even in embodiments where the parameters are not updated, or are not updated often/regularly.

### 3. The Mine Planning System

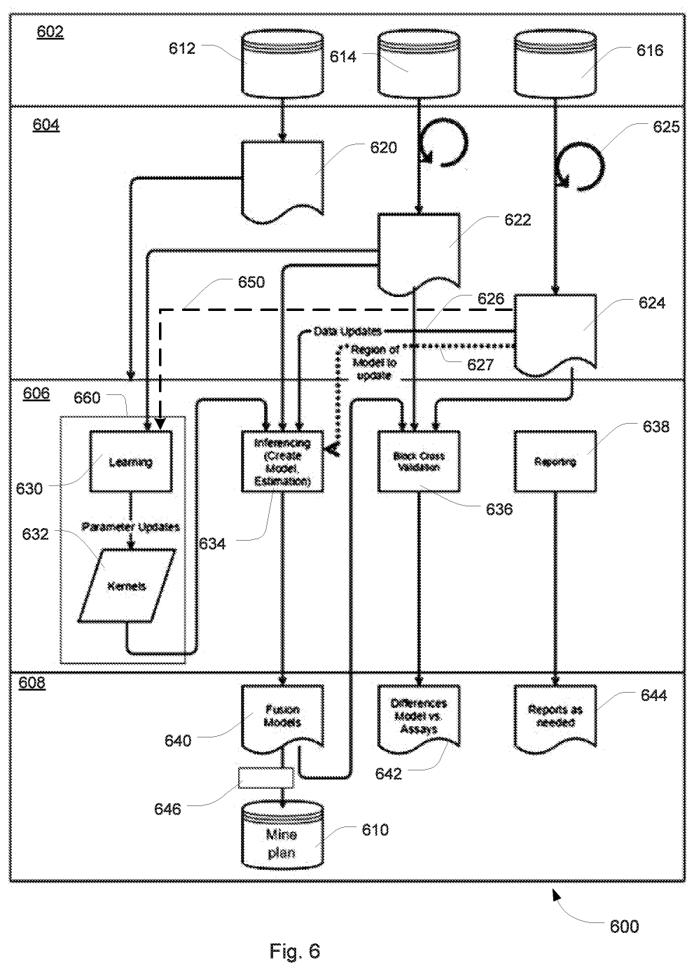

FIG. 6 is a schematic representation of a mine planning system 600 that forms part of a mining system used for directing operation of mining equipment within a mine. The mining system directs the operation of the mining equipment based on a mine plan that schedules operations in the mine. The mine planning system 600 updates the mine plan, providing an updated mine plan 610 and the mining system then directs operation of the mining equipment within the mine based on the updated mine plan 610.

that includes Data Sources 602 providing Input Data 604 that are used by a data processing module 606 to configure and output an updated Data Output 608, which includes an updated mine plan 610.

The Data Sources 602 include a block model database 612 that is a source of existing orebody models, e.g. previous and current OCMs. The block model database 612 provides existing model data 620 that describe one or more existing OCMs, the OCMs defining a respective orebody volume in terms of patterns and blocks and that may also include material property estimates associated with one or more of the blocks and/or patterns. The Data Sources 602 also include an exploration database 614 that holds evaluation drill hole data (i.e. hole locations, assays, logging, interpretation, etc.) The Data Sources 602 also includes a production database 616 for blast hole data (i.e. hole locations, assays, logging, etc.).

The existing orebody model data 620, exploration data 622, and measurement data 624 (e.g. blast hole and drilling data) are retrieved from the Data Sources 602 and provided as input data to the data processing module 606.

In addition to the existing model data 620, the data input 604 also provides initial data 622 (typically exploration or early production measurement data), and production measurement data 624 that is typically updated as production progresses.

The data processing module 606 has a learning module 660 configured to determine an inferencing model (e.g. a GP model and it model parameters) from the initial data 622, and in some embodiments to update the inferencing model and its model parameters based on the initial data and the measurement data 624.

The learning module 660 includes a Gaussian Process learning unit 630 that is responsible for machine learning of the inferencing model and its related model parameters. In some embodiments the model parameters 632 are determined and output by the learning module 660 only once, based on the initial data. In other embodiments the learning module 660 may update the inferencing model and the related model parameters taking production measurement data 624 into consideration as indicated by broken line 650.

The inferencing model determined by the learning module 660 is used by the estimation module 634 to evaluate the GP model of a material property at a desired resolution and across an orebody volume for each block in a relevant pattern. In some embodiments the estimation module 634 evaluates the GP model using the initial data (for example at the start of the analysis of an orebody volume), and in some embodiments the estimation module 634 evaluates the GP model using measurement data 624, typically the most recently acquired measurement data.

Measurement data 624 is frequently updated, note the arrow 625 indicating the repeat updating of production measurement data as new data is acquired during production. Each update typically relates to a limited, specific area of the mine. In some embodiments, the entire GP model is evaluated every time new measurement data 624 is received, however this is a computationally intensive approach. This approach is illustrated by arrow 626. In other embodiments, the GP model estimates are only updated for areas that the new measurement data relates to. This approach is illustrated by arrow 627.

In some embodiments, however, the estimation module 634 evaluates the GP model using a combination of the initial data 622 and one or more sets of production measurement data 624. The estimation module 634 is able to accommodate various data sets with potentially differing characteristics by using, for example, the unified data representation described elsewhere herein. Because multiple data sets are fused in evaluating the inferencing model, the generated model(s) are referred to as the fusion models 640.

The learning module 660 and estimation module 634 operate autonomously without human intervention. The estimation module 634 automatically determines new fusion models 640 as new measurement data 624 is made available to the learning module 660. In some embodiments the system automatically updates the fusion model 640 every time new data is available, or based on a define threshold of new data acquired. In other embodiments the system automatically updates the fusion model 640 every n defined time periods, e.g. daily. In other embodiments the fusion model 640 is automatically updated in line with the short term planning process, e.g. every 2-4 weeks.

A validator module 636 executes data analysis steps to determine how good the fusion model 640 is, i.e. how the updated OCM compares to both the exploration data and the measurement data. In some embodiments the validator module 636 relies on one or more additional data sources for assessing the model, for example an alternate model or an existing grade control process. A comparator module 642 outputs comparison data, which may be provided as a report, displayed to a user, or used as feedback into the system 600. A reporting module 638 outputs, saves, and/or displays reports 644.

The mine planning system 600 also has a mine planner module 646 that determines an updated mine plan 610 based on an existing mine plan and the fusion model 640. The fusion model 640 is used to update the mine plan in an ongoing fashion. The mine planner module 646 uses the updated estimates to update the OCM 500 and to then update the mine plan, and in particular the short term mine plan. As a result, the block order and/or drilling, blasting and digging schedules of the mine plan may be amended in view of the updated OCM 500.

To reduce computation and the time required to output an updated mine plan, in some embodiments the model parameters are determined once from the initial data (typically exploration data, but this could alternatively or additionally be production measurement data), and used as is, without re-learning the hyperparameters when measurement data 624 is received. This provides the system 600 with the ability to update the fusion models 640 and the mine plan 610 relatively quickly without the computational burden of having to optimise hyperparameters that are based on existing and new measurement data.

In other embodiments, the measurement data 624 are also used as an input to the GP learning unit 630 as indicated by broken line 650. In those embodiments the unified data representation as described elsewhere herein (and in PCT/AU2014/000025 in more detail) is used by the GP learning unit 630 to include data with differing characteristics and/or dimensions. In these embodiments, the learning module 660 may use the measurement data 624 to update the inferencing model and its model parameters, for example in the event that data circumstances change significantly enough to warrant a re-optimisation of the hyperparameters. This may be implemented, for example, by testing against a comparison threshold in the validator module 636. Therefore in some embodiments the comparison data 642 includes a validation measure such as a threshold condition. If the comparison data 642 indicates that the inferencing model should be updated, for example when the validation measure exceeds the threshold condition, then the measurement data input 650 to the GP learning unit 630 is activated and the hyperparameters are updated.

Embodiments that allow the re-optimisation of the hyperparameters provide estimates for the fusion model 640 that may result in an improved updated mine plan 610.

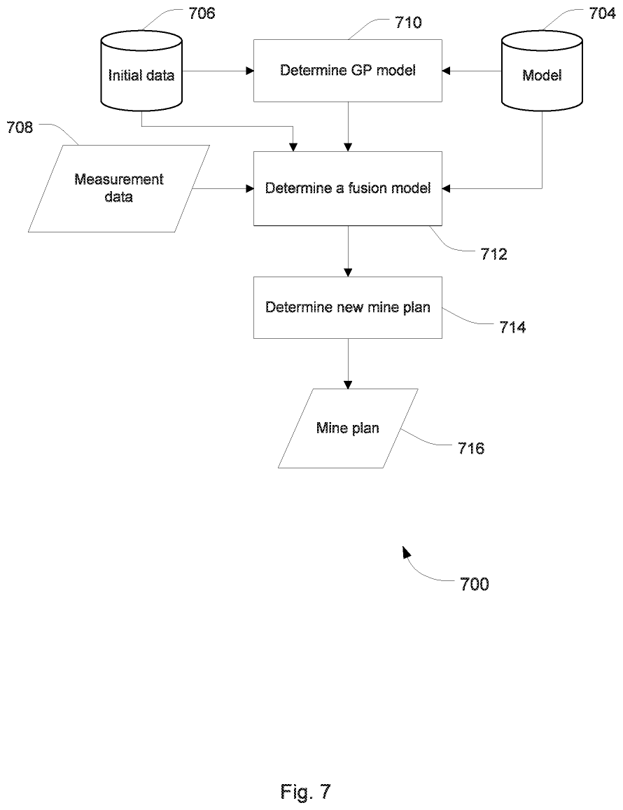

Further to the method 400 for updating a mine plan as described with reference to FIG. 4, FIG. 7 shows another embodiment of a method 700 of updating a mine plan 702. In alternative embodiments of both method 400 and method 700, the model to be updated may be based not only on exploration data, but on exploration data and initial or earlier measurement data. In these embodiments the fused model is updated based on further or later measurement data. In other embodiments there may be no exploration data, and the initial or existing model is determined based on initial or earlier measurement data alone.

Referring to FIG. 7, the method 700 includes receiving existing model data 704, initial data 706, and production measurement data 708. The method 700 determines an inferencing model 710 (e.g. a GP model) and its model parameters (including hyperparameters) from the initial data 706. The method 700 evaluates the inferencing model 710 to determine a fusion model 712 within the framework of the existing model data 704 and based on the production measurement data 708. In some embodiments the inferencing model is evaluated based on one or more sets of production measurement data 708, e.g. data that becomes available over time as production progresses. In some embodiments the inferencing model is evaluated based on the initial data and one or more sets of production measurement data.

At 714, the method 700 then determines an updated mine plan 716 based on the mine plan 702 and the fusion model 712.

The methods and systems described herein provide improved orebody estimates that support the improved execution of a mine plan in order to meet production targets. The resulting updated mine plans are based on two estimates: an estimate based on production sampling or inspection, and an estimate of the orebody from sparse sampling which is subject to change when data is gathered in this region at a later time.

A short term mine plan (which may span, for example, 2 or 3 or 4 months) is an optimised schedule that takes into account operational constraints (e.g. machine maintenance, shot availability for drill and load etc., available stock, etc.), plant constraints (e.g. plant maintenance and restrictions), and marketing or commercial constraints (e.g. required shipping grades). If any of these constraints change, then the tonnes and/or grade of the material available may also change so that it may be necessary to deploy, for example, out of plan material and/or machinery. This type of variability and risk may be reduced by using the fusion model 640 of the systems and methods described herein as the likelihood of variability will be reduced by basing the mine plan on improved data. Improved data as provided by the fusion model 640 results in an improved schedule that is likely to require less unexpected or unplanned fixes when things go wrong, such quick fixes typically reducing both productivity and efficiency.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

Any embodiment of the invention is meant to be illustrative only and is not meant to be limiting to the invention. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A mining system for directing operation of mining equipment within a mine based on a mine plan that schedules operations in the mine, the system including:
a mine planning system for updating the mine plan, the mine planning system including:
a data input module providing initial data, and measurement data;
a data processing module including:
a learning module configured to determine an inferencing model from the initial data; and
an estimation module configured to evaluate the inferencing model using the initial data and the measurement data, wherein thus evaluating the inferencing model provides a fusion model; and
a mine planner module that determines an updated mine plan based on an existing mine plan and the fusion model,
wherein the mining system directs operation of the mining equipment within the mine based on the updated mine plan.

2. The mining system of claim 1, wherein the measurement data includes a plurality of data sets with varying dimensionality.

3. The mining system of claim 2, wherein the estimation module accommodates the plurality of data sets with varying dimensionality by using a unified data representation.

4. The mining system of claim 1, wherein the learning module is further configured to update the inferencing model based on the measurement data.

5. The mining system of claim 4, wherein updating the inferencing model includes updating one or more model parameters of the inferencing model.

6. The mining system of claim 4 further including a validator module that assesses the fusion model in view of the measurement data to prompt the learning module to update the inferencing model.

7. The mining system of claim 1, wherein the measurement data includes production measurement data obtained continuously during operation of the mine.

8. The mining system of claim 1,
wherein the estimation module estimates an updated orebody model based on the fusion model, and
wherein the mine planner module uses the updated orebody model to determine the updated mine plan.

9. The mining system of claim 1, wherein the initial data includes exploration data and measurement data.

10. A method of directing operation of mining equipment within a mine based on a mine plan that schedules operations in the mine, the method including:
updating the mine plan, the updating including:
receiving initial data;
determining an inferencing model and its model parameters from the initial data;
receiving measurement data;
using the received measurement data and the initial data to evaluate the inferencing model to determine a fusion model; and
determining an updated mine plan based on the mine plan and the fusion model; and
directing operation of the mining equipment based on the updated mine plan.

11. The method of claim 10 further including updating an orebody model from the fusion model, and wherein determining the updated mine plan is also based on the updated orebody model.

12. The method of claim 11 further including validating the fusion model in view of the measurement data to provide a validation measure, and prompting the updating based on the validation measure.

13. The method of claim 10, wherein the initial data includes exploration data.

14. The method of claim 10, wherein the measurement data includes production measurement data received continually during operation of the mine.

15. The method of claim 10, wherein the measurement data includes a plurality of data sets with varying dimensionality.
